(19) United States
(12) Patent Application Publication
(10) Pub. No.: US 2019/0137814 A1
(43) Pub. Date: May 9, 2019

(54) DISPLAY PANEL AND METHOD OF MANUFACTURING THE SAME

(71) Applicant: HKC Corporation Limited, Shenzhen City, Guangdong (CN)

(72) Inventor: Beizhou HUANG, Shenzhen City, Guangdong (CN)

(21) Appl. No.: 15/743,003

(22) PCT Filed: Dec. 21, 2017
(86) PCT No.: PCT/CN2017/117656

§ 371 Date: Jan. 9, 2018

(30) Foreign Application Priority Data
Nov. 3, 2017 (CN) 201711071344.1

(51) Int. Cl. G02F 1/1335; G02F 1/1333

(52) U.S. Cl. CPC G02F 1/133514; G02F 1/133512; G02F 2201/123; G02F 2001/133357; G02F 1/133371

(57) ABSTRACT

The present disclosure is related to a display panel and a method for manufacturing the same. The display panel comprises a first substrate, a second substrate disposed in parallel with the first substrate, a liquid crystal layer interposed between the first substrate and the second substrate, an active switch array disposed on the second substrate, a color filter layer disposed on the active switch array, the color filter layer having a plurality of color filter units, and a planarization layer disposed on the plurality of color filter units, the planarization layer having different thicknesses in an area corresponding to a portion of the color filter units.

### FIELD OF THE INVENTION

The present disclosure relates to a display panel, and more particularly to a liquid crystal display apparatus having different heights in cell gaps to improve the characteristics of a colored image under wide view angle displaying.

### BACKGROUND OF THE INVENTION

The Liquid Crystal Display is a flat display apparatus utilizes the characteristics of the liquid crystal material to display an image. The liquid crystal display has advantages of lighter and thinner, lower driving voltage and low power consumption comparing with other display apparatus, and it has become the mainstream product in the entire consumption marketing. Nowadays, the manufacturing process of the liquid crystal display is roughly composed of a front end process with array techniques, a middle section process with ceiling techniques and a back end process with modularization techniques. In the front end process, it is producing an active switch array substrate also named TFT array substrate and a color film substrate. The major purpose of the middle section process is to bond the active switch array substrate and the color film substrate together, and injecting the liquid crystal material into the gap between active switch array substrate and the color film substrate to form a liquid crystal layer. Then, further step is cutting precedent bonded substrates into individual liquid crystal panel according to the requirements of product sizes. In the back end process, the modularization techniques are employed to equip several semi-finished products like the combination of the liquid crystal panel and the backlight module, panel drive circuit, and frame, etc. for the liquid crystal display apparatus.

The liquid crystal display panel capable of presenting a colorized image, mainly depends upon the function produced by the color filter. The backlight source of the liquid crystal display forms a gray scale light source through the control of the liquid crystal and the driving IC. Due to the color filter is coated with three colorized pigment resistance of red, green and blue, so that the red light, the green light and the blue light are formed by the gray scale light source through the color filter, and finally the colorized image is presented by mixing. Therefore, the color filter is a key component of the liquid crystal display, and the basic structure of the color filter is composed of a glass substrate, a black matrix layer, a colorized pigment resistance layer and a transparent conductive layer (i.e., indium tin oxide, ITO) and the like.

In the conventional, the color filters used in an active switch array liquid crystal display panel are all formed on a first substrate. Regarding the manufacturing process, although the process capability of the first substrate, the second substrate (TFT array substrate) and the color filter can be made to realize higher resolution and very fine graphics. However, when the first substrate and the second substrate are attached to alignment and undergoing the pressed down, the offset distance between the first substrate and the second substrate is necessary to take into consideration, so that a certain tolerance for left and right deviation must be reserved on a line width of the black matrix of the color filter.

The tolerance for a line width of the black matrix it will cause the liquid crystal display having the raising in the resolution but the decreasing in the luminousness accordingly, therefore the brightness of the backlight must be increased and the consumption of electricity also increased significantly. If the brightness of the backlight keeps constant, the overall contrast ratio will be a significant decline. In addition, the black matrix is formed by two layers composed of chromium (Cr) and chromium oxide (CrOx) or three layers composed of chromium (Cr), chromium oxide (CrOx) and chromium nitrogen (CrNy). Expect for the highly cost, the chromium is a metal material so that the chromium waste liquid generated in the etching process also belongs to high harmful substances, and environmental pollution can be caused.

In order to overcome the aforementioned problem, a color filter layer of the new generation liquid crystal display panel certainly needs to be made on an array substrate, so that a solution can be found for the problem. Therefore, a color filter on array (COA) structure having the black matrix composed of resin instead of the chromium, and a method of manufacturing the color filter layer on the second substrate (i.e., TFT array substrate) are created. The color filter on array structure and the manufacturing method thereof having the advantages of firstly the cost can be reduced, secondly the pollution to the environment cannot be caused, and thirdly a precise alignment procedure is not required when the two substrates are attached.

The COA manufacturing process comprises firstly coating a red colorized pigment resistance on the second substrate having an active switch array module disposed thereon by spin coater, then pre-baking, exposing, developing, and then baking to curing. After a plurality of red resist units are finished, then repeatedly performing the processes of coating, pre-baking, exposing, developing, and baking to curing to finish a plurality of green resist units, and a plurality of blue resist units on the second substrate sequentially. Continually performing a planarization layer and performing a black matrix on the second substrate respectively. On the other side, a transparent conductive layer (such as, indium tin oxide, ITO) is sputtered onto the first substrate. Finally, the first substrate and the second substrate are bonded and filled with liquid crystals. However, the aforementioned planarization layer will keep a height inside a cell gap structure of the liquid crystal display panel substantially the same, this condition causes the color of the image slightly yellowish when the liquid crystal display panel using in the wide view angle. The display quality influenced by the cell gap structure is the problem to be overcome for the manufacturing techniques.

### SUMMARY OF THE INVENTION

In order to solve the aforementioned technical problem, it is an object of the present invention to provide a display panel, and more particularly to a display panel having improvements in the colored image phenomenon, so that it can show perfect colored image quality to achieve the broader usability.

For solving aforementioned technical problem, the present invention utilizes a semi-transparent layer photomask adopted for exposing a planarization layer, and therefore the planarization layer including different thicknesses correspond to the respective red resist units, green resist units and blue resist units of the color filter. Another way provides the planarization layer having a portion of uneven surface such as rugged, concave, convex, groove or the likes, so that the cell gaps having different heights corresponding to the thickness variations of the planarization layer regarding the portion of the surface. Thus, the colored image phenomenon of the display panel under wide view angle displaying is improved and also the overall display quality of liquid crystal display panel is enhanced.

The purpose of the present invention and the aforementioned technical problem to be solved can be further realized by the following technical embodiments.

The present invention provides a display panel comprising a first substrate, a second substrate disposed in parallel with the first substrate, a liquid crystal layer interposed between the first substrate and the second substrate, an active switch array disposed on the second substrate, a color filter layer disposed on the active switch array and including a plurality of color filter units, and a planarization layer disposed on the plurality of color filter units. The planarization layer has different thicknesses in an area corresponding to a portion of the color filter units. Thus, the colored image phenomenon of the display panel is improved and the overall display quality of liquid crystal display panel is enhanced.

In one embodiment of the present invention, the plurality of color filter units of the color filter layer comprise a plurality of red resist units, a plurality of green resist units, and a plurality of blue resist units.

In one embodiment of the present invention, the first substrate is a color filter substrate.

In one embodiment of the present invention, a pattern of pixel electrode is disposed on the planarization layer.

In one embodiment of the present invention, a black matrix is disposed on the planarization layer.

In one embodiment of the present invention, the black matrix comprises a resin material.

In one embodiment of the present invention, a cell gap structure having a plurality of cell gaps is formed between the first substrate and the second substrate, each of the cell gaps comprises a height depending on a thickness of the corresponding planarization layer.

In one embodiment of the present invention, a cell gap structure having a plurality of cell gaps is formed between the first substrate and the second substrate, each of the cell gaps comprises a height depending on a thickness of the corresponding planarization layer and a thickness of the corresponding colored resist unit.

In one embodiment of the present invention, a cell gap structure having a plurality of cell gaps is formed between the first substrate and the second substrate, a height difference between a maximum height of the cell gaps and a minimum height of the cell gaps is in a range of 0.3 μm to 0.1 μm.

In one embodiment of the present invention, the plurality of the color filter units include a thickness in a range of 1.0 μm to 1.2 μm.

The present invention also provides a method of manufacturing a display panel comprising providing a first substrate and a second substrate opposing disposed, forming an active switch array module on the second substrate, forming a color filter layer on the active switch array module and the color filter layer including a plurality of color filter units, forming a planarization layer on the plurality of the color filter units and the planarization layer including different thicknesses in an area corresponding to a portion of the color filter units, forming a pattern of the black matrix on the plurality of the color filter units and forming a pattern of the pixel electrode on the planarization layer sequentially, forming a transparent grounding electrode on the first substrate, and forming a liquid crystal layer between the first substrate and the second substrate.

In one embodiment of the present invention, the plurality of color filter units of the color filter layer comprise a plurality of red resist units, a plurality of green resist units, and a plurality of blue resist units.

In one embodiment of the present invention, the first substrate is a color filter substrate.

In one embodiment of the present invention, a cell gap structure having a plurality of cell gaps is formed between the first substrate and the second substrate, each of the cell gaps comprises a height depending on a thickness of the corresponding planarization layer.

In one embodiment of the present invention, a cell gap structure having a plurality of cell gaps is formed between the first substrate and the second substrate, each of the cell gaps comprises a height depending on a thickness of the corresponding planarization layer and a thickness of the corresponding colored resist unit.

In one embodiment of the present invention, a cell gap structure having a plurality of cell gaps is formed between the first substrate and the second substrate, a height difference between a maximum height of the cell gaps and a minimum height of the cell gaps is in a range of 0.3 μm to 0.1 μm.

In one embodiment of the present invention, the plurality of the color filter units includes a thickness in a range of 1.0 μm to 1.2 μm.

The present invention provides another display panel comprising a first substrate, a second substrate disposed in parallel with the first substrate, a liquid crystal layer interposed between the first substrate and the second substrate, an active switch array disposed on the second substrate, a color filter layer disposed on the active switch array and including a plurality of color filter units, and a planarization layer disposed on the plurality of color filter units and the planarization layer including different thicknesses in an area corresponding to a portion of the color filter units. Wherein, the plurality of color filter units of the color filter layer comprises a plurality of red resist units, a plurality of green resist units, and a plurality of blue resist units. The first substrate is a color filter substrate. A cell gap structure has a plurality of cell gaps formed between the first substrate and the second substrate, and a height difference between a maximum height of the cell gaps and a minimum height of the cell gaps is in a range of 0.3 μm to 0.1 μm.

According to the different heights in the cell gap structure inside the TFT liquid crystal display panel provided by the present invention, it can improve the colored image phenomenon of the display panel under wide view angle displaying also enhance the overall display quality of liquid crystal display panel.

Various other objects, advantages and features of the present invention will become readily apparent from the ensuing detailed description, and the novel features will be particularly pointed out in the appended claims.

### BRIEF DESCRIPTION OF FIGURES

The following detailed descriptions, given by way of example, and not intended to limit the present invention solely thereto, will be best be understood in conjunction with the accompanying figures:

FIG. 1 is a schematic view of a partial structure of a first embodiment of the present invention; and

FIG. 2 is a schematic view of a partial structure of a second embodiment of the present invention.

### DETAILED DESCRIPTION OF THE EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

The drawings and description are to be regarded as illustrative in nature and not restrictive. Like reference numerals designate like elements throughout the specification. In addition, the size and thickness of each component shown in the drawings are arbitrarily shown for understanding and ease of description, but the present invention is not limited thereto. In the drawings, the thickness of layers, films, panels, regions, etc., are exaggerated for clarity. In the drawings, for understanding and ease of description, the thicknesses of some layers and areas are exaggerated. It will be understood that, when an element such as a layer, film, region, or substrate is referred to as being “on” another element, it can be directly on the other element or intervening elements may also be present.

Furthermore, in the specification, “on” implies being positioned above or below a target element and does not imply being necessarily positioned on the top on the basis of a gravity direction.

For further explaining the technical means and efficacy of the present invention, the display panel including the embodiments, structures, features and effects thereof according to the present invention will be apparent from the following detailed description and accompanying drawings.

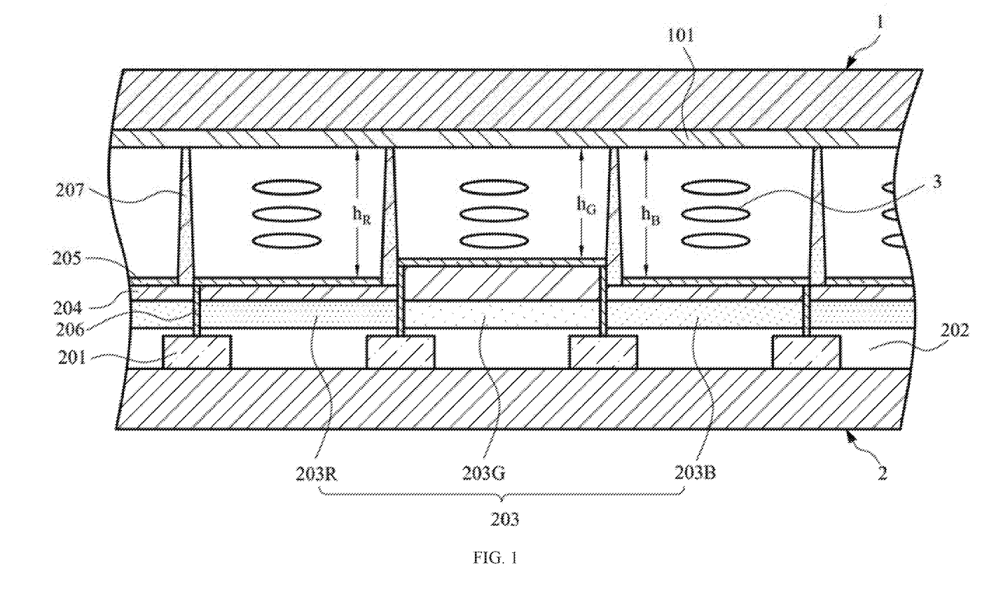

Referring to FIG. 1, FIG. 1 is a first embodiment of liquid crystal display panel of the present invention. The present invention provides a liquid crystal display panel fabricated by one kind of the COA manufacturing processes, the liquid crystal display panel comprises a first substrate 1 and a second substrate 2 opposing disposed, and a liquid crystal layer 3 interposed between the first substrate 1 and the second substrate 2.

Further, the second substrate 2 as shown in FIG. 1 is the TFT substrate. An active switch array module 201 is disposed on the second 2 and configured for driving the liquid crystals 3 interposed between the first substrate 1 and the second substrate 2. A plurality of color filter units 203 of the color filter layer comprises a plurality of red resist units 203R, a plurality of green resist units 203G, and a plurality of blue resist units 203B and directly arrayed on the active switch array module 201 of the second substrate 2. An isolate protective layer 202 is interposed between the active switch array module 201 and the plurality of color filter units 203. The plurality of color filter units 203 is configured for filtering the light emitting from the bottom into the desired color light. A planarization layer 204 is disposed above the color filter units 203, used to isolate and protect the color filter units 203. A pattern of pixel electrode is disposed above the color filter units 203 and the planarization layer 204, and configured for driving a plurality of the liquid crystal molecules to tilt and control the color filter units lighting. A plurality of the connect electrodes 206 are arrayed between the active switch array module 201 and the pattern of the pixel electrode 205, and crossing through the planarization layer 204, the isolate protective layer 202 and the color filter units. The connect electrodes 206 are configured for electrical connecting the active switch array module 201 and the pattern of the pixel electrode 205. A black matrix 207 is further arrayed above the planarization layer 204 and configured for shielding the color light from the different color filter units.

In the aforementioned manufacturing processes and the structure, in the case of the planarization layer 204 employing in the structure, the thicknesses of the color filter units is in a range of 1.0 μm to 1.2 μm. Besides, the pattern of the pixel electrode 205 and the active switch array module 201 have a portion overlapped, therefore, if the dielectric coefficient of the planarization layer 204 is not low enough, a capacitance phenomenon can be formed, and the electric leakage is caused. In general, the value of the dielectric coefficient must be less than 3, so that the problem can be avoided.

Similarly, in the case of the structure without the planarization layer 204, the value of the dielectric coefficient of the colorized pigment resistance used in the color filter units 203 must be less than 3. In addition, the black matrix 207 in contact with the pattern of pixel electrode 205 is an electrically insulating substance, so that the material may select from the resin. The film thickness of the resin is about I μm, and the optical density value is greater than 2.

Further, referring to the first substrate 1 as shown in FIG. 1, it is a color filter substrate, but in the present embodiment the color filter layer is instead of arraying on the second substrate 2 corresponding to the COA manufacturing processes. Thus, simply only a transparent conductive layer (i.e., indium tin oxide, ITO) 101 is required to be sputtering on the first substrate 1, then, sealing with the second substrate 2 and further injecting the liquid crystals into the gap of a pair of substrates to complete the liquid crystal display device.

General liquid crystal display panel during the usage, the planarization layer will keep a height inside a cell gap structure of the liquid crystal display panel substantially the same and thereby a portion of color light passing through the color filter units having a total reflection phenomenon easily formed on the plane surface of the planarization layer. This condition causes the color of the image slightly yellowish when the liquid crystal display panel using in the wide view angle, and affect the displaying quality of cell gaps.

In order to overcome this problem, in the present embodiment it is adjusting the thickness of the planarization layer 204 above the color filter units of the color filter layer. The planarization layer 204 is arranged with different thicknesses in accordance with the red colored unit 203R, green colored unit 203G and blue colored unit 203B under the requirement of different color light. Consequently, the different heights of cell gap such as h_{R}, h_{G} and h_{B} are generated and the cell structure having different heights of cell gap is formed. Therefore, it can improve the colored image phenomenon of the display panel also enhance the overall display quality of liquid crystal display panel. In the present embodiment, a height difference between a maximum height of the cell gaps and a minimum height of the cell gaps is in a range of 0.3 μm to 0.1 μm.

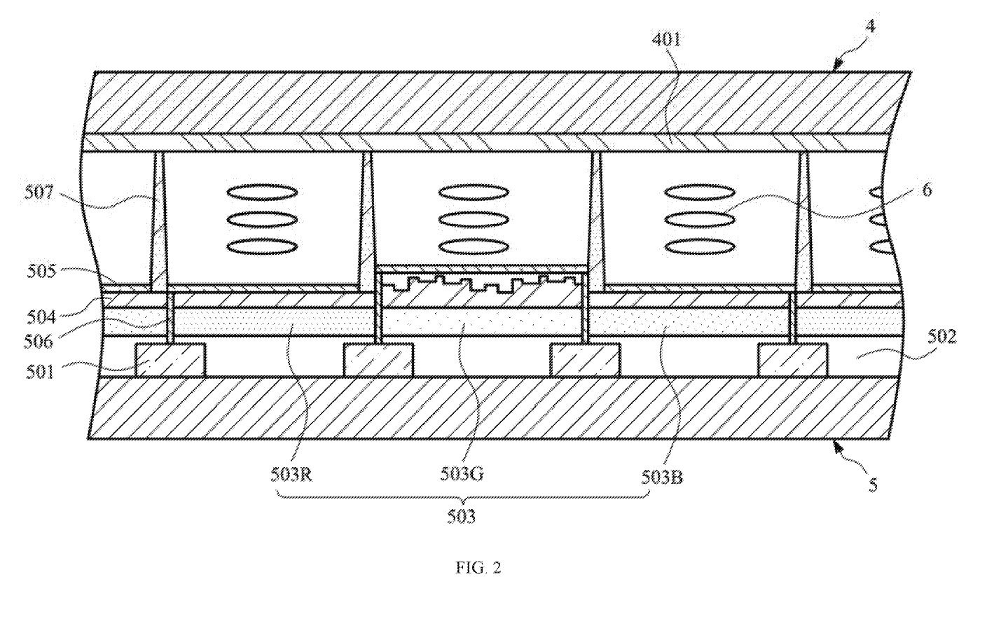

Referring to FIG. 2, FIG. 2 is a second embodiment of liquid crystal display panel of the present invention. The present invention provides a liquid crystal display panel also fabricated by one kind of the COA manufacturing processes, the liquid crystal display panel comprises a first substrate 4 and a second substrate 5 opposing disposed, and a liquid crystals 6 interposed between the first substrate 4 and the second substrate 5. Furthermore, referring to the second substrate 5, the second substrate 5 is substantially the same with the first embodiment. An active switch array module 501 is disposed on the second 5 and configured for driving the liquid crystals 6 interposed between the first substrate 4 and the second substrate 5. A plurality of color filter units 503 of the color filter layer are comprises a plurality of red resist units 503R, a plurality of green resist units 503G, and a plurality of blue resist units 503B and directly arrayed on the active switch array module 501 of the second substrate 5. An isolate protective layer 502 is interposed between the active switch array module 501 and the plurality of color filter units 503. The plurality of color filter units 503 is configured for filtering the light emitting from the bottom into the desired color light.

A planarization layer 504 is disposed above the color filter units 503, used to isolate and protect the color filter units 503. A pattern of pixel electrode is disposed above the color filter units 503 and the planarization layer 504, and configured for driving a plurality of the liquid crystal molecules to tilt and control the color filter units lighting.

A plurality of the connect electrodes 506 are arrayed between the active switch array module 501 and the pattern of the pixel electrode 505, and crossing through the planarization layer 504, the isolate protective layer 502 and the color filter units. The connect electrodes 506 are configured for electrical connecting the active switch array module 501 and the pattern of the pixel electrode 505. A black matrix 507 is further arrayed above the planarization layer 204 and configured for shielding the color light from the different color filter units.

The difference between the present embodiment and the first embodiment is the thickness of the planarization layer 504 above the different color filter units substantially the same. The way to overcome the aforementioned problem is provides a portion of a surface of the planarization layer arranged with patterns such as rugged, concave, convex, groove or the likes, so that the cell gaps having different heights corresponding to the thickness variations of the planarization layer regarding the portion of the surface. Thus, the colored image phenomenon of the display panel is improved and also the overall display quality of liquid crystal display panel is enhanced. In the present embodiment, a height difference between a maximum height of the cell gaps and a minimum height of the cell gaps is in a range of 0.3 μm to 0.1 μm.

According to the different heights in the cell gap structure inside the TFT liquid crystal display panel provided by the present invention, it can improve the colored image phenomenon of the display panel under wide view angle displaying also enhance the overall display quality of liquid crystal display panel.

In addition, in the specification, unless explicitly described to the contrary, the word “comprise” and variations such as “comprises” or “comprising” will be understood to imply the inclusion of stated elements but not the exclusion of any other elements.

The present invention has been described with a preferred embodiment thereof and it is understood that many changes and modifications to the described embodiment can be carried out without departing from the scope and the spirit of the invention that is intended to be limited only by the appended claims.

1. A display panel, comprising:
a first substrate;
a second substrate, disposed in parallel with the first substrate;
a liquid crystal layer, interposed between the first substrate and the second substrate;
an active switch array, disposed on the second substrate;
a color filter layer, disposed on the active switch array and including a plurality of color filter units; and
a planarization layer, disposed on the plurality of color filter units and including different thicknesses in an area corresponding to a portion of the color filter units;
wherein the planarization layer corresponding to a portion of the color filter units including rough surface;
wherein the plurality of color filter units have same thickness; and
wherein a cell gap structure having a plurality of cell gaps is formed between the first substrate and the second substrate, and a height difference between a maximum height of the cell gaps and a minimum height of the cell gaps is in a range of 0.3 μm to 0.1 μm.

2. The display panel according to claim 1, wherein each of the plurality of color filter units of the color filter layer comprises a plurality of red resist units, a plurality of green resist units, and a plurality of blue resist units.

3. (canceled)

4. The display panel according to claim 1, further comprising a pattern of pixel electrode disposed on the planarization layer.

5. The display panel according to claim 1, further comprising a black matrix disposed on the planarization layer.

6. The display panel according to claim 5, wherein the black matrix comprises a resin material.

7. The display panel according to claim 1, wherein a cell gap structure having a plurality of cell gaps is formed between the first substrate and the second substrate, each of the cell gaps comprises a height depending on a thickness of the corresponding planarization layer.

8. The display panel according to claim 1, wherein a cell gap structure having a plurality of cell gaps is formed between the first substrate and the second substrate, each of the cell gaps comprises a height depending on a thickness of the corresponding planarization layer and a thickness of the corresponding colored resist unit.

9. (canceled)

10. The display panel according to claim 1, wherein each of the plurality of the color filter units includes a thickness in a range of 1.0 μm to 1.2 μm.

11. A method of manufacturing a display panel, comprising steps of:
providing a first substrate and a second substrate opposing disposed;
forming an active switch array module on the second substrate;
forming a color filter layer on the active switch array module, the color filter layer including a plurality of color filter units;
forming a planarization layer on the plurality of the color filter units, the planarization layer including different thicknesses in an area corresponding to a portion of the color filter units;
forming a pattern of the black matrix on the plurality of the color filter units and forming a pattern of the pixel electrode on the planarization layer sequentially;
forming a transparent grounding electrode on the first substrate; and
forming a liquid crystal layer between the first substrate and the second substrate;
wherein the planarization layer corresponding to a portion of the color filter units including rough surface;
wherein the plurality of color filter units have same thickness; and
wherein a cell gap structure having a plurality of cell gaps is formed between the first substrate and the second substrate, and a height difference between a maximum height of the cell gaps and a minimum height of the cell gaps is in a range of 0.3 μm to 0.1 μm.

12. The manufacturing method according to claim 11, wherein each of the plurality of color filter units of the color filter layer comprises a plurality of red resist units, a plurality of green resist units, and a plurality of blue resist units.

13. (canceled)

14. The manufacturing method according to claim 11, wherein a cell gap structure having a plurality of cell gaps is formed between the first substrate and the second substrate, each of the cell gaps comprises a height depending on a thickness of the corresponding planarization layer.

15. The manufacturing method according to claim 11, wherein a cell gap structure having a plurality of cell gaps is formed between the first substrate and the second substrate, each of the cell gaps comprises a height depending on a thickness of the corresponding planarization layer and a thickness of the corresponding colored resist unit.

16. (canceled)

17. The manufacturing method according to claim 11, wherein each of the plurality of the color filter units includes a thickness in a range of 1.0 μm to 1.2 μm.

18. A display panel, comprising:
a first substrate;
a second substrate, disposed in parallel with the first substrate;
a liquid crystal layer, interposed between the first substrate and the second substrate;
an active switch array, disposed on the second substrate;
a color filter layer, disposed on the active switch array and including a plurality of color filter units; and
a planarization layer, disposed on the plurality of color filter units and including different thicknesses in an area corresponding to a portion of the color filter units;
wherein the planarization layer corresponding to a portion of the color filter units including rough surface;
wherein the plurality of color filter units have same thickness; and
wherein, each of the plurality of color filter units of the color filter layer comprises a plurality of red resist units, a plurality of green resist units, and a plurality of blue resist units; the first substrate is a color filter substrate; and a cell gap structure having a plurality of cell gaps formed between the first substrate and the second substrate, and a height difference between a maximum height of the cell gaps and a minimum height of the cell gaps in a range of 0.3 μm to 0.1 μm.
